(19) United States
(12) Patent Application Publication
(10) Pub. No.: US 2006/0236886 A1
(43) Pub. Date: Oct. 26, 2006

(54) Process for the offset printing of a catalytic species via a hydrophilic phase

(75) Inventors: Luc Leenders, Herentals (BE); Michel Werts, Antwerpen (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Agfa-Gevaert, Mortsel (BE)

(21) Appl. No.: 11/112,012

(22) Filed: Apr. 20, 2005

(51) Int. Cl. B41F 3/34

(52) U.S. Cl. 101/492

(57) ABSTRACT

An offset printing process comprising the steps of: applying a hydrophilic phase to a printing plate with or without an oleophilic phase, the hydrophilic phase comprising at least one catalytic species, and applying the hydrophilic phase applied to the printing plate to a receiving medium thereby realizing in a single step a functional pattern of the at least one catalytic species on the receiving medium, wherein, if the hydrophilic phase is applied with the oleophilic phase, the oleophilic and hydrophilic phases are either applied separately from an ink and a fountain medium or are applied together in the form of a single fluid ink, the single fluid ink consisting of a dispersing phase and a dispersed phase, and the hydrophilic phase is exclusive of an ionomer.

### FIELD OF THE INVENTION

The present invention relates to a process for the offset printing of a catalytic species via a hydrophilic phase.

### BACKGROUND OF THE INVENTION

### Offset Printing

Offset (lithographic) printing presses use a so-called printing master such as a printing plate which is mounted on a cylinder of the printing press. In conventional offset printing, the master carries a lithographic image on its surface, which consists of oleophilic (or hydrophobic, i.e. ink-accepting, water-repelling) areas as well as hydrophilic (or oleophobic, i.e. water-accepting, ink-repelling) areas. A print is obtained by first applying a fountain medium (also called dampening liquid) and then the ink to lithographic image on the surface of the printing plate on a drum, both are then transferred to an intermediate (rubber) roll, known as the offset blanket, from which they are further transferred onto the final substrate.

The fountain medium is first transferred via a series of rolls to the printing plate. It conventionally acts as a weak sacrificial layer and prevents ink from depositing on the non-image area of the plate and has the function of rebuilding the non-printing (desensitized) areas of the printing plate during a press run. This is usually realized with an aqueous solution of acid, usually phosphoric acid, and gum arabic, the gum is adsorbed to the metal of the plate and thereby making a hydrophilic surface. In conventional offset the dampened plate then contacts an inking roller and only accepts the oleophilic ink in the oleophilic image areas. Fountain media have historically contained isopropyl alcohol to reduce the surface tension and thereby to provide for more uniform dampening of the printing plate, but, by eliminating (or greatly reducing) the isopropyl alcohol as a fountain medium additive, printers are able to reduce VOC (volatile organic compound) emissions significantly. In such fountain media isopropyl alcohol is replaced with lower volatility glycols, glycol ethers, or surfactant formulations. Conventional fountain media may also contain anti-corrosion agents, pH-regulators and surfactants.

In addition to conventional offset printing, several alternative offset printing methods have been developed, such as reverse lithography, driography and single fluid offset printing.

In reverse lithography, a water- or glycol-based hydrophilic colored ink is used in combination with an oleophilic fountain medium. The printing plate contains image areas which preferentially attract a hydrophilic liquid and non-image areas which are repellent to the hydrophilic liquids. Printing plates can be prepared by applying a pattern of a material with a good tolerance to aqueous (miscible) liquids such as a vinylacetate-ethylene copolymer resin, polyester resin or a composition containing shellac, polyethylene glycol and wax onto a hydrophobic base sheet, such as polystyrene or polyethylene coated Mylar. Alternatively, the printing plate can be prepared by applying a hydrophilic liquid-repelling thermosetting siloxane composition as the non-image pattern on a zinc base material (U.S. Pat. No. 3,356,030). Additives like carbon black or zinc oxide may be added to the resin to increase the surface roughness, thereby improving the ink uptake. The hydrophilic inks can be dye- or pigment-based and contain a binder and water and/or ethylene glycol as the main vehicle. The hydrophobic fountain medium is based on hydrocarbons (such as Textile Spirits or Super Naphtolite), mineral oils or silicon oils.

Waterless or driographic offset printing was developed, for example by Toray Industries of Japan, to reduce the emission of VOCs from the fountain medium in conventional offset printing by dispensing with a fountain medium and only using an oleophilic ink. The non-image areas of a driographic printing plate are coated with an ink-repellant polymer, such as a silicone, while the image areas are ink-accepting surfaces for example a grained aluminium base plate, optionally overcoated with an additional coating layer. During driographic printing, only ink is supplied to the master.

However, these driographic printing processes still have the disadvantage of VOC emission from the oleophilic ink. This has resulted in the development of water-based driographic inks, which contain surfactants, rewetting agents, dyes and/or pigments and resins in addition to water. Such driographic printing plates can be used, with any hydrophilic surface, for example, the grained aluminium surface of the printing plate as the image areas and any type of hydrophobic material that repels the ink for the non-image area.

Conventional offset and reverse offset printing require the continuous monitoring and adjusting of the ink/fountain balance so that the ink adheres exclusively to the printing areas of the plate to ensure the production of sharp, well-defined prints. Single-fluid inks have been developed to eliminate the need for the operator continuously to monitor and adjust the ink/fountain balance. These inks consist of a fine emulsion of the ink in the fountain or of a fine emulsion of the fountain in the ink and are applied to the printing plate via the ink rollers. The fountain is oleophilic when the ink is hydrophilic and is hydrophilic when the ink is oleophilic e.g. with the oleophilic ink part based on vinyl- and hydrocarbon resins with dyes and/or pigments and the hydrophilic fountain part based on glycol/water mixtures.

Reverse offset printing inks using a hydrocarbon or mineral oil as fountain medium are described in for example U.S. Pat. No. 3,532,532, U.S. Pat. No. 3,797,388 and GB 1,343,784A. None of these patents disclose the addition of functional materials to the hydrophobic fountain medium or to the hydrophilic ink other than dyes and/or pigments.

Water-based driographic offset inks are for example described in WO 99/27022A, WO 03/057789A and DE 4119348A. None of these patents discloses the addition to the hydrophilic ink of functional materials, other than dyes and/or pigments.

Single fluid inks for offset printing are, for example, disclosed in U.S. Pat. No. 4,981,517 and in WO 00/032705A, but neither discloses an ink containing functional materials in the hydrophilic (fountain) part of the ink emulsion.

ELECTRODAG® screen printing pastes for printing metallic layers are commercially available from Acheson and an inkjet printing process for printing metallic layers is disclosed in WO patent 03/032084A. However, screen and ink-jet printing techniques are relatively slow and high drying/curing temperatures are required to fuse the metal particles together to achieve a high conductivity.

EP-A 1 415 826 discloses a process for the offset printing of a receiving medium with a functional pattern comprising in any order the steps of: applying a printing ink to a printing plate and wetting said printing plate with an aqueous fountain medium containing a solution or a dispersion containing at least one moiety having at least colouring, pH-indicating, whitening, fluorescent, phosphorescent, X-ray phosphor or conductive properties.

### Preparation of Catalyst Patterns

U.S. Pat. No. 4,906,296 discloses a fountain solution for transporting a catalytic, cross-linking agent to lithographic printing ink and infusing the catalytic agent into the ink, the fountain solution comprising water, gum and a catalytic, cross-linking agent adapted to cross-link the ink upon exposure to ultraviolet radiation, infrared radiation or hot air. However, the use of the term catalytic is incorrect, since the cross-linking agent is consumed.

DE 2757029A discloses a process for the manufacture of integrated circuits in which an ink enriched with palladium, copper or silver nuclei is printed on a substrate provided with an adhesion-providing layer, the conductive patterns thereby produced then being metallized chemically in a copper depositing bath to electrically conductive circuits. Neither the printing method nor the ink compositions are further specified.

WO 92/21790A discloses a method comprising a catalytic ink in a two-dimensional image on a moving web from a rotating gravure roll; wherein said catalytic ink comprises a solution of less than 10% by weight solids comprising polymer and a Group 1B or Group 8 metal compound, complex or colloid; wherein said ink has a viscosity between 20 and 600 centipoises as measured with a Brookfield No. 1 spindle at 100 rpm and 25° C.; and wherein said image is adaptable to electroless deposition of metal. Rotogravure printing has the advantages of being a fast printing method, while the ink is free from additives, such as binders that could reduce the activity of the catalyst or embed the catalyst in a binder layer, making it non-accessible to perform its catalytic function. However, this process suffers from the disadvantages of the high cost of a gravure roll compared to an offset printing plate.

U.S. Pat. No. 6,521,285 discloses a method for electroless deposition of conductive material (8) on a substrate (5), using a stamp (1) having a surface onto which an ink is applied, preconditioning said substrate (5) by providing a seed layer (6) having enhanced affinity between said ink and said preconditioned substrate, and bringing said surface of said stamp (1) into contact with said preconditioned substrate (5), comprising the steps of: treating said surface of said stamp (1) to render said surface wettable by said ink, pressing said surface of said stamp (1) covered with said ink being a catalyst (4) in molecular form and being polar onto said substrate (5), thereupon separating said stamp (1) from said substrate (5) by leaving at least part of a layer (7) of said catalyst onto said substrate (5) and electroless plating said substrate (5) in areas of said surface being covered with said layer of catalyst (7) with said conductive material (8). However, this method is not roll-to-roll and is very slow compared to offset printing.

JP 2002-223095A discloses the manufacture of an electromagnetic wave shield material by forming a shield ink layer on a base material by printing conductive ink and magnetic ink by flexography to a pattern shape as a shield layer 2. Alternately, after a catalytic ink layer 4 comprising electroless plating catalyst is printed to a pattern shape by flexography in a base material, a metallic plating layer 5 is formed directly on a catalytic ink layer alone as a shield layer by electroless plating. However, this method requires relatively high viscosity inks, usually of the order of 200-600 mPa.s, for which binders are required. Other additives such as defoamers, waxes, surfactants, slip agents and plasticizers are often required to obtain the required printing properties.

U.S. Pat. No. 5,751,325 discloses an ink jet printing process comprising the steps of image-wise projecting droplets of liquid onto a receiving material thus bringing into working relationship on said receiving material a reducible metal compound (A), a reducing agent (B) for said metal compound and physical development nuclei (C) that catalyze the reduction of said metal compound to metal. Preferred nuclei are colloidal noble metal particles, e.g. silver particles and colloidal heavy metal sulfide particles such as palladium sulfide, nickel sulfide and mixed silver-nickel sulfide. However, inkjet printing is a relatively slow process.

GB 1,326,389A discloses a process of producing a metal image having varying tones and shadows on a substrate therefor which comprises the steps of: (a) inscribing on a substrate a continuous tone image having such varying tones and shadows, said image comprising nucleating imaging material; and (b) contacting the inscribed image-forming material to form a continuous tone metal image on the inscribed areas thereof. However, the nuclei pattern is not replicated to produce multiple metallic patterns.

EP 1 387 422A discloses a process for application of a catalyst ink, including screen printing, stencil printing, spraying, transfer printing or doctor blading, onto a substrate, said ink comprising electrocatalyst, ionomer, water, surfactant and optionally organic solvent, said process comprising the steps of: (a) coating of a catalyst ink to a substrate in a compartment with controlled humidity and temperature; (b) levelling the deposited catalyst ink in a compartment with controlled humidity and temperature; and (d) drying the catalyst-coated substrate at elevated temperatures. Only screen printing is exemplified and coating in a compartment with controlled humidity and temperature is required.

US 2003/0148159 discloses a method of preparing an electrode for an electrical device, comprising: forming a catalyst ink comprising catalyst agglomerates with controlled particle size and porosity; applying, including by gravure printing, said catalyst ink onto a surface of a membrane to form a catalytic layer comprising a plurality of three dimensional structural units comprising said catalyst agglomerates. However, gravure rolls are very expensive.

U.S. Pat. No. 3,989,526 discloses in EXAMPLE 12 the printing of the surface of an element with a rubber stamp with a freshly prepared suspension of colloidal gold to form an imagewise distribution of metallic gold nuclei as a catalyst for the redox reaction according to the invention disclosed in U.S. Pat. No. 3,989,526.

U.S. Pat. No. 4,285,276 discloses a method for lithographic printing wherein a lithographic printing plate having oleophilic and hydrophilic areas on the printing surface of the plate is contacted with ink and an aqueous fountain dampening solution during printing, the improvement comprising said fountain solution being an aqueous solution containing a water-soluble hydrolase enzyme dissolved therein to improve printing quality and reduce the amount of fountain solution necessary to dampen the plate. U.S. Pat. No. 4,285,276 discloses the use of active and inactive enzymes of the hydrolase type such as amylase, lipase, maltase, papain, pepsin, protease, sucrase, trypsin, diastase, rapidase, chymotrypsin A, acetyl-cholinesterase and the like. Since U.S. Pat. No. 4,285,276 discloses the use of both active and inactive enzymes, it is evident that the inventors did not contemplate the use of the process disclosed in U.S. Pat. No. 4,285,276 for the printing of a functional pattern of catalyst species on a receiving medium.

EP-A 0 652 436 discloses a method for manufacturing a bio-sensor comprising the steps of: manufacturing an enzyme paste, forming a thick film amperometric device on an insulating substrate; forming an enzyme immobilized layer by printing, including screen printing, the enzyme paste on amperometric device; and printing and forming an outer electrode on the electrode of amperometric device. The aqueous immobilized enzyme paste comprises carbon black, NAD⁺ (cofactor), an enzyme and hydroxyethylcellulose.

US 2004/0061841 discloses a method of manufacturing a non-mediated biosensor for indicating amperometrically the catalytic activity of an oxidoreductase enzyme in the presence of a fluid containing a substance acted upon by said enzyme, the method comprising the steps of: (a) taking a base substrate having a working electrode and a reference electrode thereon, and conductive tracks connected to the said working and reference electrodes for making electrical connections with a test meter apparatus; (b) printing on the said working electrode an ink containing finely divided platinum group metal or oxide and a resin binder; (c) causing or permitting the said printed ink to dry to form an electrically conductive base layer comprising the said platinum group metal or oxide bonded together by the resin; and (d) forming a top layer on the base layer by coating the base layer with a coating medium comprising or containing a buffer; wherein (e) a catalytically active quantity of said oxidoreductase enzyme is provided in at least one of said printed ink and said coating medium. The enzyme paste comprises in addition to the enzyme a resin binder, Pt/carbon particles, graphite, a surfactant and an organic solvent. Both patents use screen printing as the chosen technique to apply the enzyme layers.

EP-A 0 691 408 discloses a UV-polymerizable enzyme paste for the manufacture of biosensors, particularly thick film biosensors, containing a) UV-polymerizable screen-printable base material, b) at least one enzyme, wherein the enzyme is incorporated into the base material, and optionally c) mediators, co-factors and/or enzyme stabilizers. This suffers from the disadvantage of poor accessibility of the enzymes in the layer and hence poor sensitivity of the sensor.

WO 04/039600A discloses a method of improving print quality in a web manufacturing process wherein said web manufacturing process includes at least one print station adapted to print enzymes on a moving substrate, said web manufacturing process comprising the steps of: continuously moving said substrate through said process; depositing enzyme ink onto said substrate through a screen printing process wherein ink is deposited on a top side of said screen and forced through said top side onto said substrate which is positioned adjacent to a bottom side of said screen; humidifying air at said top side of said screen to a first relative humidity; humidifying air at said bottom side of said screen to a second relative humidity.

WO 92/05415A discloses a time-temperature indicator in which an enzyme is employed, characterized by a substrate and an enzyme which catalyzes reaction of the substrate to produce directly a reaction product at different colour to the substrate, the enzyme optionally laid down by ink-jet printing. However, ink-jet printing is a slow printing technique and can therefore not be used on-line in an offset package printing line.

There is therefore a need for a fast, low-cost printing method for the mass production of functional patterns of catalytic species on a substrate under ambient conditions. In respect of catalytic species, the avoidance of additives is preferred to prevent poisoning of the catalytic species and the resulting reduction in catalytic activity and to avoid embedding of catalytic species due to the resulting inaccessibility of the catalytic species.

### ASPECTS OF THE INVENTION

It is therefore an aspect of the present invention to provide a process for producing a functional pattern of catalytic species.

Further aspects and advantages of the invention will become apparent from the description hereinafter.

### SUMMARY OF THE INVENTION

Surprisingly it has been found that if, in a conventional offset printing process using standard offset ink, the standard fountain is substituted by a fountain solution or dispersion containing a catalytic species, the conventional wetting and repairing function of a fountain can be augmented by coating the hydrophilic areas of the printing plate with a pattern of catalytic species, which are then transferred in the printing process to a receiving medium, thereby endowing the receiving medium with a pattern of catalytic species capable of catalyzing a process i.e. providing the receiving medium with a pattern of a functional species, namely a catalytic species. Furthermore, a high resolution pattern of a catalytic species can be realized on a receiving medium from an aqueous phase in a single step, without resorting to photographic techniques, in a low cost high speed process which lends itself to mass production. Moreover, the catalytic species thereby deposited do not require activation prior to use.

Aspects of the present invention have been realized by an offset printing process comprising the steps of: applying a hydrophilic phase to a printing plate with or without an oleophilic phase, the hydrophilic phase comprising at least one catalytic species, and applying the hydrophilic phase applied to the printing plate to a receiving medium thereby realizing in a single step a functional pattern of the at least one catalytic species on the receiving medium, wherein, if the hydrophilic phase is applied with the oleophilic phase, the oleophilic and hydrophilic phases are either applied separately from an ink and a fountain medium or are applied together in the form of a single fluid ink, the single fluid ink consisting of a dispersing phase and a dispersed phase, and the hydrophilic phase is exclusive of an ionomer. This process can be carried out under ambient conditions and does not require coating in a compartment with controlled humidity and temperature.

Preferred embodiments are disclosed in the dependent claims.

### DETAILED DESCRIPTION OF THE INVENTION

### Definitions

The term “alkoxy” means all variants possible for each number of carbon atoms in the alkoxy group i.e. for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

The term “aqueous medium” means a medium containing water and water-miscible organic solvents containing between 50% by weight of water and 100% by weight of water.

The term “layer”, as used in disclosing the present invention, means a continuous coating unless qualified by the adjective “non-continuous”.

The term “pattern”, as used in disclosing the present invention, means a non-continuous coating, which may be an array, arrangement or configuration of lines and/or shapes, areas and/or regions.

The term “functional” in the expression “functional patterns” as used in disclosing the present invention means having at least one function that is non-decorative, although functional materials as used in disclosing the present application may have a decorative function or utility in addition to a non-decorative function or utility. Examples of such functions are non-decorative colouring, pH-indicating, whitening, fluorescent, phosphorescent, X-ray phosphor, conductive properties and catalysis. The term functional pattern therefore includes patterns of catalytic species.

The term “catalytic species” in the expression “patterns of catalytic species”, as used in disclosing the present invention, is a species selected from the group consisting of catalysts, autocatalysts and catalyst and autocatalyst precursors.

The term “catalyst”, as used in disclosing the present invention, means a water-soluble and/or -dispersible moiety, molecule, particle or micro-organism not including water-soluble hydrolase enzymes which alters the rate and/or selectivity of a chemical, biological or biochemical reaction, or a physical process such as crystallization, deposition, phase separation, etc., without itself being consumed i.e. it can accelerate or decelerate a chemical reaction e.g. electroless deposition. The term catalyst does not include species which of themselves have no catalytic properties, although they may be precursors of a species which does perform the function of a catalyst.

The term “catalyst” is to be distinguished over the term “autocatalyst”, which is a catalyst, which itself is a product of a reaction which itself was catalytic.

The term “electroless deposition”, as used in disclosing the present invention, means deposition of conducting species, such as metals, without using electrochemical techniques. Electroless deposition techniques usually involve a reaction between an oxidizing and a reducing species.

The term “hydrophilic phase”, as used in disclosing the present invention, is an offset fountain medium, a hydrophilic offset ink, a hydrophilic driographic ink or the aqueous part of an offset single fluid ink. It is a phase with substantially hydrophilic properties i.e. containing or having an affinity for, attracting, adsorbing, or absorbing water. The hydrophilic phase mainly contains water and hydrophilic substances e.g. alcohols and cellulose derivatives, although small quantities of hydrophobic substances may be present.

The term “flexible”, as used in disclosing the present invention, means capable of following the curvature of a curved object such as a drum e.g. without being damaged.

The term “ink”, as used in disclosing the present invention, means an ink, which may or may not be pigmented with a colorant, the colorant being at least one dye and/or at least one pigment and which is suitable for offset printing i.e. if the ink is oleophilic it accepted by the oleophilic areas of a printing master plate, commonly known as a printing plate, or if the ink is hydrophilic it accepted by the hydrophilic areas of a printing master plate, commonly known as a printing plate.

The term “dye”, as used in disclosing the present invention, means a colouring agent having a solubility of 10 mg/L or more in the medium in which it is applied and under the ambient conditions pertaining.

The term “pigment”, as used in disclosing the present invention, is defined in DIN 55943, herein incorporated by reference, as an inorganic or organic, chromatic or achromatic colouring agent that is practically insoluble in the application medium under the pertaining ambient conditions, hence having a solubility of less than 10 mg/L therein.

The term “binder”, as used in disclosing the present invention, means a polymeric species, which may be naturally occurring material, a modified naturally occurring material or a synthetic material.

The term “coated paper”, as used in disclosing the present invention, means paper coated with any substance i.e. includes both clay-coated paper and resin-coated paper.

PET as used in the present disclosure represents poly(ethylene terephthalate).

The term “diffusion transfer reversal (DTR) process”, as used in disclosing the present invention, refers to a process developed independently by A. Rott [GB patent 614,155 and Sci. Photogr., (2) 13, 151(1942)] and E. Weyde [DE patent 973,769] and described by G. I. P. Levenson in Chapter 16 of “The Theory of the Photographic Process Fourth Edition”, edited by T. H. James, pages 466 to 480, Eastman Kodak Company, Rochester (1977), herein incorporated by reference.

The term “ionomer”, as used in disclosing the present invention, means a polymer with covalent bonds between the elements of the chain, and ionic bonds between the chains e.g. metal salts of copolymers of ethylene and methacrylic acid commercialized by Du Pont under the tradename SURLYN®.

### Offset Printing Process

Aspects of the present invention have been realized by an offset printing process comprising the steps of: applying a hydrophilic phase to a printing plate with or without an oleophilic phase, the hydrophilic phase comprising at least one catalytic species, and applying the hydrophilic phase applied to the printing plate to a receiving medium thereby realizing in a single step a functional pattern of the at least one catalytic species on the receiving medium, wherein, if the hydrophilic phase is applied with the oleophilic phase, the oleophilic and hydrophilic phases are either applied separately from an ink and a fountain medium or are applied together in the form of a single fluid ink, the single fluid ink consisting of a dispersing phase and a dispersed phase, and the hydrophilic phase is exclusive of an ionomer.

According to a first embodiment of the process, according to the present invention, the ink is the oleophilic phase.

### Single Fluid Ink

According to a second embodiment of the process, according to the present invention, the dispersing phase in the single fluid ink is the hydrophilic phase. The hydrophilic phase in single fluid inks is mainly based on ethylene glycols. To prevent coagulation and maintain a high efficiency of the catalyst, it may be necessary to replace a part of the ethylene glycols with water.

According to a third embodiment of the process, according to the present invention, the dispersing phase in the single fluid ink is the oleophilic phase.

### Hydrophilic Phase

Aspects of the present invention have been realized by an offset printing process comprising the steps of: applying a hydrophilic phase to a printing plate with or without an oleophilic phase, the hydrophilic phase comprising at least one catalytic species, and applying the hydrophilic phase applied to the printing plate to a receiving medium thereby realizing in a single step a functional pattern of the at least one catalytic species on the receiving medium, wherein, if the hydrophilic phase is applied with the oleophilic phase, the oleophilic and hydrophilic phases are either applied separately from an ink and a fountain medium or are applied together in the form of a single fluid ink, the single fluid ink consisting of a dispersing phase and a dispersed phase, and the hydrophilic phase is exclusive of an ionomer.

The hydrophilic phase may also contain: water-soluble gums, a pH buffer system, desensitizing salts, acids or their salts, wetting agents, solvents, non-piling or lubricating additives, emulsion control agents, viscosity builders, biocides, defoamers and colouring agents. However, the presence of additives in the hydrophilic phase should be avoided if at all possible to prevent pollution/poisoning of the catalytic species with resulting reduction in catalytic activity.

According to a fourth embodiment of the process, according to the present invention, the hydrophilic phase only contains water and the catalytic species.

According to a fifth embodiment of the process, according to the present invention, the hydrophilic phase further contains at least one water-miscible organic compound, such as aliphatic alcohols, ketones, arenes, esters, glycol ethers, cyclic ethers, such as tetrahydrofuran, and their mixtures, preferably an organic solvent.

According to a sixth embodiment of the process, according to the present invention, less than 10% by weight of the dissolved and dispersed solids in the hydrophilic phase is binder.

According to a seventh embodiment of the process, according to the present invention, less than 5% by weight of the dissolved and dispersed solids in the hydrophilic phase is binder. Minimalization of binder-content enables the catalytic species to exhibit maximum activity and prevents embedding of the catalytic species, making them non-accessible.

According to an eighth embodiment of the process, according to the present invention, the catalytic species is present in hydrophilic phase in a concentration of 10⁻⁸ to 1 mol/L, preferably between 0.001 and 0.1 mol/L.

According to a ninth embodiment of the process, according to the present invention, the hydrophilic phase further contains an anti-foaming agent. Suitable anti-foaming agents include the silicone antifoam agent X50860A from Shin-Etsu.

According to a tenth embodiment of the process, according to the present invention, the hydrophilic phase has a pH between 1.5 and 5.5.

According to an eleventh embodiment of the process, according to the present invention, the hydrophilic phase further contains a water-soluble gum, such as gum arabic, larch gum, CMC, PVP, and acrylics.

According to a twelfth embodiment of the process, according to the present invention, the fountain medium is the hydrophilic phase.

According to a thirteenth embodiment of the process, according to the present invention, the ink is the hydrophilic phase.

According to a fourteenth embodiment of the process, according to the present invention, the hydrophilic phase applied without an oleophilic phase is a water-based driographic ink.

### Catalytic Species

Aspects of the present invention have been realized by an offset printing process comprising the steps of: applying a hydrophilic phase to a printing plate with or without an oleophilic phase, the hydrophilic phase comprising at least one catalytic species, and applying the hydrophilic phase applied to the printing plate to a receiving medium thereby realizing in a single step a functional pattern of the at least one catalytic species on the receiving medium, wherein, if the hydrophilic phase is applied with the oleophilic phase, the oleophilic and hydrophilic phases are either applied separately from an ink and a fountain medium or are applied together in the form of a single fluid ink, the single fluid ink consisting of a dispersing phase and a dispersed phase, and the hydrophilic phase is exclusive of an ionomer.

According to a fifteenth embodiment of the process, according to the present invention, the at least one catalytic species requires no activation prior to the at least one catalytic species exhibiting catalytic activity.

According to a sixteenth embodiment of the process, according to the present invention, the catalytic species is a catalyst or an autocatalyst.

According to a seventeenth embodiment of the process, according to the present invention, the catalytic species is selected from the group consisting of metallic particles, organic compounds, inorganic compounds, organometallic compounds, polymers, microporous species, microorganisms, antibodies, and enzymes exclusive of water-soluble hydrolase enzymes. Examples of microporous species include zeolites.

An example of a microorganism that functions as a catalyst is yeast cells. The yeast cells can be present in the water-based fountain medium in a conventional offset printing process, a hydrophilic (e.g. aqueous) offset ink, the hydrophilic phase of a single fluid ink or a hydrophilic (e.g. water-based) driographic ink.

According to an eighteenth embodiment of the process, according to the present invention, the catalytic species is nickel or iron particles. Nickel or iron particles can catalyze the growth of carbon nanotubes and can be printed via the water-based fountain medium in a conventional offset printing process, a hydrophilic (e.g. aqueous) offset ink, the hydrophilic phase of a single fluid ink or a hydrophilic (e.g. water-based) driographic ink.

According to a nineteenth embodiment of the process, according to the present invention, the catalytic species is an antibody.

Solutions or dispersions of catalytic antibodies (abzymes) are described, for example, in ‘Catalytic Antibodies, edited by E. Keinan, Wiley-VCH, Weinheim (2004). Abzymes catalyze reactions by the stabilization of the transition state of a reaction, thereby decreasing the activation energy and allowing for more rapid conversion of substrate to product. Examples are abzyme 28B4 which catalyzes periodate oxidation of p-nitrotoluene-methyl sulfide to sulfoxide and the commercial abzyme 38C2 which catalyzes the aldol addition of a wide variety of aliphatic open chain and aliphatic cyclic ketones to various aromatic and aliphatic aldehydes. Abzymes can be printed via the water-based fountain medium in a conventional offset printing process, a hydrophilic (e.g. aqueous) offset ink, the hydrophilic phase of a single fluid ink, or a hydrophilic (e.g. water-based) driographic ink.

According to a twentieth embodiment of the process, according to the present invention, the at least one catalytic species is a mix of different catalytic species e.g. development nuclei and enzymes. The mix of different catalyst species can be printed via the water-based fountain medium in a conventional offset printing process, a hydrophilic (e.g. aqueous) ink in a reverse offset printing process, the hydrophilic phase of a single fluid ink, or a hydrophilic (e.g. water-based) driographic ink.

According to a twenty-first embodiment of the process, according to the present invention, the catalytic species is a polymerization catalyst, which include but are not limited to organometallic, metallocene, transition metal and zeolite catalysts. Polymerization catalysts can be printed via the water-based fountain medium in a conventional offset printing process, a hydrophilic (e.g. aqueous) offset ink, the hydrophilic phase of a single fluid ink, or a hydrophilic (e.g. water-based) driographic ink.

According to a twenty-second embodiment of the process, according to the present invention, the catalytic species is an enzyme exclusive of water-soluble hydrolase enzymes. Offset printing of enzyme patterns can result in biologically active devices for sensing. Different enzymes that may be used include, but are not limited to, glucose oxidase, cholesterol oxidase, urease, urea amidolyase, lactate oxydase, glutamate oxidase, choline oxidase, peroxidase, alcohol oxidase, alcohol dehydrogenase, creatinine amidohydrolase, oxalate oxidase, hydroxybutyrate dehydrogenase, galactose oxidase, L-gluconolactone oxidase, sarcosine oxidase and glycolate oxidase. The solution or dispersion of enzymes can be present in a water-based fountain, a hydrophilic (e.g. aqueous) offset ink, the hydrophilic phase of a single fluid ink, or a hydrophilic (e.g. water-based) driographic ink.

According to a twenty-third embodiment of the process, according to the present invention, the catalytic species is selected from the group consisting of electroless deposition catalysts, electrocatalysts, development nuclei, polymerization catalysts, structure specific catalysts, biological process catalysts, biochemical process catalysts, fuel cell catalysts, a gas diffusion catalysts and gas-phase reaction catalysts.

According to a twenty-fourth embodiment of the process, according to the present invention, the catalytic species is an electrocatalyst. Such electrocatalysts can be used in solid type fuel cells, gas diffusion electrodes or membrane/electrode assemblies, such as carbon-supported platinum or platinum-based particles, optionally alloyed with palladium, molybdenum etc. A dispersion of electrocatalyst particles can be printed via a water-based fountain, a hydrophilic (e.g. aqueous) offset ink, the hydrophilic phase of a single fluid ink, or a hydrophilic (e.g. water-based) driographic ink.

According to a twenty-fifth embodiment of the process, according to the present invention, the hydrophilic phase comprises other functional ingredients e.g. selected from the group consisting of fluorescent, phosphorescent, pH-indicating, coloring, whitening and intrinsically conductive ingredients.

### Electroless Deposition Catalyst

According to a twenty-sixth embodiment of the process, according to the present invention, the catalytic species is an electroless deposition catalyst.

Development nuclei of the type well known in diffusion transfer reversal (DTR) image receiving materials are preferred electroless deposition catalysts e.g. noble metal particles, such as silver particles, and colloidal heavy metal sulfide particles, such as colloidal palladium sulfide, nickel sulfide and mixed silver-nickel sulfide. These nuclei may be present with or without a binder.

According to a twenty-seventh embodiment of the process, according to the present invention, the catalytic species is a non-metallic electroless deposition catalyst e.g. palladium, silver, nickel, and cobalt sulphides.

According to a twenty-eighth embodiment of the process, according to the present invention, the catalytic species is a heavy metal sulphide electroless deposition catalyst e.g. palladium, silver, nickel, cobalt, copper, lead and mercury sulphides, or a mixed sulphide, e.g. silver-nickel sulphide.

According to a twenty-ninth embodiment of the process, according to the present invention, the catalytic species is a metallic electroless deposition catalyst e.g. silver, platinum, rhodium, iridium, gold, ruthenium, palladium and copper particles.

According to a thirtieth embodiment of the process, according to the present invention, the catalytic species is capable of catalyzing the electroless deposition of silver.

### Fountain Medium

According to a thirty-first embodiment of the process, according to the present invention, the fountain medium has a viscosity at 25° C. after stirring to constant viscosity of at least 0.75 mPa.s as measured according to DIN 53211 i.e. until successive measurements according to DIN 53211 are reproducible.

According to a thirty-second embodiment of the process, according to the present invention, the fountain medium has a viscosity at 25° C. after stirring to constant viscosity of at least 10 mPa.s as measured according to DIN 53211 i.e. until successive measurements according to DIN 53211 are reproducible.

According to a thirty-third embodiment of the process, according to the present invention, the fountain medium has a viscosity at 25° C. after stirring to constant viscosity of at least 30 mPa.s as measured according to DIN 53211 i.e. until successive measurements according to DIN 53211 are reproducible.

According to a thirty-fourth embodiment of the process, according to the present invention, the fountain medium has a viscosity at 25° C. after stirring to constant viscosity of at least 100 mPa.s as measured according to DIN 53211 i.e. until successive measurements according to DIN 53211 are reproducible.

According to a thirty-fifth embodiment of the process, according to the present invention, the fountain medium has a viscosity at 25° C. after stirring to constant viscosity of at least 200 mPa.s as measured according to DIN 53211 i.e. until successive measurements according to DIN 53211 are reproducible.

### Colouring Agents

Aspects of the present invention have been realized by an offset printing process comprising the steps of: applying a hydrophilic phase to a printing plate with or without an oleophilic phase, the hydrophilic phase comprising at least one catalytic species, and applying the hydrophilic phase applied to the printing plate to a receiving medium thereby realizing in a single step a functional pattern of the at least one catalytic species on the receiving medium, wherein, if the hydrophilic phase is applied with the oleophilic phase, the oleophilic and hydrophilic phases are either applied separately from an ink and a fountain medium or are applied together in the form of a single fluid ink, the single fluid ink consisting of a dispersing phase and a dispersed phase, and the hydrophilic phase is exclusive of an ionomer.

According to a thirty-sixth embodiment of the process, according to the present invention, the hydrophilic phase further comprises at least one colouring agent, the colouring agent being at least one pigment and/or at least one dye. Transparent coloured compositions can be realized by incorporating pigments e.g. azo pigments e.g. DALMAR® Azo Yellow and LEVANYL® Yellow HRLF, dioxazine pigments e.g. LEVANYL® Violet BNZ, phthalocyanine blue pigments, phthalocyanine green pigments, Molybdate Orange pigments, Chrome Yellow pigments, Quinacridone pigments, Barium precipitated Permanent Red 2B, manganese precipitated BON Red, Rhodamine B pigments and Rhodamine Y pigments.

According to a thirty-seventh embodiment of the process, according to the present invention, the hydrophilic phase further comprises a colouring agent, which is at least one dye.

Suitable dyes include:

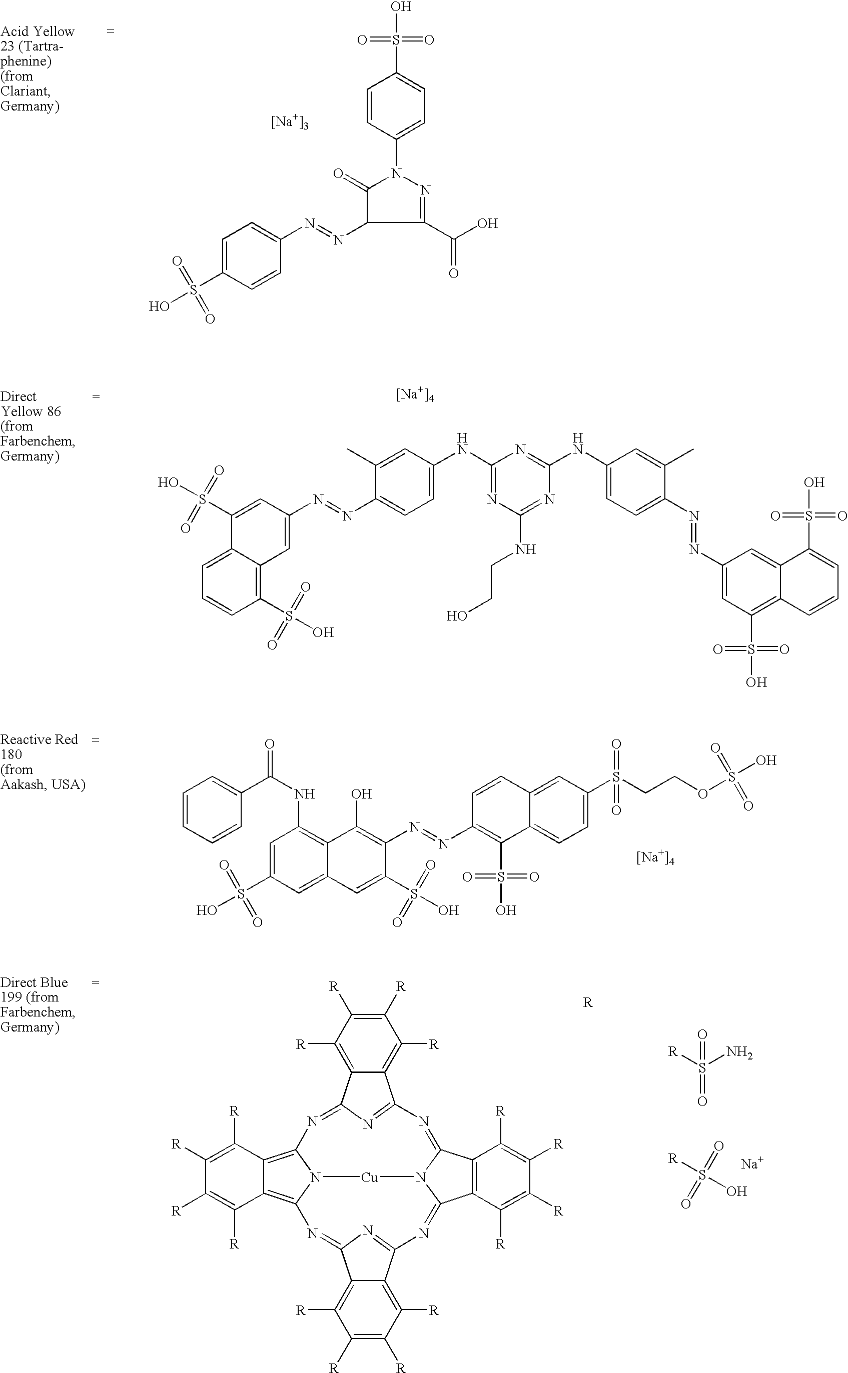

According to a thirty-eighth embodiment of the process, according to the present invention, if the oleophilic phase is coloured, the hydrophilic phase contains at least one dye and/or at least one pigment such that the colour tone of the ink and the background cannot be distinguished by the human eye e.g. by colour matching or colour masking by for example matching the CIELAB a*, b* and L* values as defined in ASTM Norm E179-90 in a R(45/0) geometry with evaluation according to ASTM Norm E308-90.

According to a thirty-ninth embodiment of the process, according to the present invention, if the hydrophilic phase is coloured, the oleophilic phase contains at least one dye and/or at least one pigment such that the colour tone of the ink and the background cannot be distinguished by the human eye e.g. by colour matching or colour masking by matching the CIELAB a*, b* and L* values as defined in ASTM Norm E179-90 in a R(45/0) geometry with evaluation according to ASTM Norm E308-90.

### Surfactants

According to a fortieth embodiment of the process, according to the present invention, the hydrophilic phase further contains at least one surfactant i.e. at least one surfactant selected from the group consisting of cationic, anionic, amphoteric and non-ionic surfactants.

According to a forty-first embodiment of the process, according to the present invention, the hydrophilic phase further contains at least one non-ionic surfactant e.g. ethoxylated/fluoroalkyl surfactants, polyethoxylated silicone surfactants, polysiloxane/polyether surfactants, ammonium salts of perfluoro-alkylcarboxylic acids, polyethoxylated surfactants and fluorine-containing surfactants.

Suitable non-ionic surfactants include:
NON01 SURFYNOL® 440: an acetylene compound with two polyethylene oxide chains having 40 wt % of polyethylene oxide groups from Air Products
NON02 SYNPERONIC®13/6.55 a tridecylpolyethylene-glycol
NON03 ZONYL® FSO-100: a mixture of ethoxylated fluoro-surfactants with the formula:
   F(CF₂CF₂)₁₋₇CH₂CH₂O(CH₂CH₂O)_{y}H where y=0 to ca. 15 from DuPont;
NON04 ARKOPAL™ N060: a nonylphenylpolyethylene-glycol from HOECHST
NON05 FLUORAD® FC129: a fluoroaliphatic polymeric ester from 3M
NON06 PLURONIC® L35 a polyethylene-glycol/propylene-glycol
NON07 TEGOGLIDE® 410: a polysiloxane-polymer copolymer surfactant, from Goldschmidt;
NON08 TEGOWET®: a polysiloxane-polyester copolymer surfactant, from Goldschmidt;
NON09 FLUORAD® FC126: a mixture of ammonium salts of perfluorocarboxylic acids, from 3M;
NON10 FLUORAD® FC430: a 98.5% active fluoroaliphatic ester from 3M;
NON11 FLUORAD® FC431: CF₃(CF₂)₇SO₂(C₂H₅)N—CH₂CO—(OCH₂CH₂)ₙOH from 3M;
NON12 Polyoxyethylene-10-lauryl ether
NON13 ZONYL® FSN: a 40% by weight solution of F(CF₂CF₂)₁₋₉CH₂CH₂O(CH₂CH₂O)ₓH in a 50% by weight solution of isopropanol in water where x=0 to about 25, from DuPont;
NON14 ZONYL® FSN-100: F(CF₂CF₂)₁₋₉CH₂CH₂O(CH₂CH₂O).ₓH where x=0 to about 25, from DuPont;
NON15 ZONYL® FS300: a 40% by weight aqueous solution of a fluorinated surfactant, from DuPont;
NON16 ZONYL® FSO: a 50% by weight solution of a mixture of ethoxylated fluoro-surfactants with the formula: F(CF₂CF₂)₁₋₇CH₂CH₂O(CH₂CH₂O)_{y}H where y=0 to ca. 15 in a 50% by weight solution of ethylene glycol in water, from DuPont.

According to a forty-second embodiment of the process, according to the present invention, the hydrophilic phase further contains at least one anionic surfactant. Suitable anionic surfactants include:
AN01 HOSTAPON® T a 95% concentrate of purified sodium salt of N-methyl-N-2-sulfoethyl-oleylamide, from HOECHST
AN02 LOMAR® D 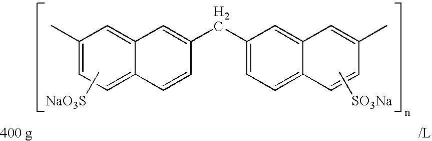
AN03 AEROSOL® OT an aqueous solution of 10 g/L of the sodium salt of the di-2-ethylhexyl ester of sulphosuccinic acid from American Cyanamid
AN04 DOWFAX 2A1 a 45% by weight aqueous solution of a mixture of the sodium salt of bis(p-dodecyl, sulpho-phenyl)-ether and the sodium salt of (p-dodecyl, sulpho-phenyl)(sulpho-phenyl)ether from Dow Corning
AN05 SPREMI tetraethylammonium perfluoro-octylsulphonate
AN06 TERGO sodium 1-isobutyl, 4-ethyl-n-octylsulphate
AN07 ZONYL® 7950 a fluorinated surfactant, from DuPont;
AN08 ZONYL® FSA a 25% by weight solution of F(CF₂CF₂)₁₋₉CH₂CH₂SCH₂CH₂COOLi in a 50% by weight solution of isopropanol in water, from DuPont;
AN09 ZONYL® FSE: 14% by weight solution of [F(CF₂CF₂)₁₋₇CH₂CH₂O]ₓP(O)(ONH₄)_{y} where x=1 or 2; y=2 or 1; and x+y=3 in a 70% by weight solution of ethylene glycol in water, from DuPont;
AN10 ZONYL® FSJ: 40% by weight solution of a blend of F(CF₂CF₂)₁₋₇CH₂CH₂O]ₓP(O)(ONH₄)_{y} where x=1 or 2; y=2 or 1; and x+y=3 with a hydrocarbon surfactant in 25% by weight solution of isopropanol in water, from DuPont;
AN11 ZONYL® FSP 35% by weight solution of [F(CF₂CF₂)₁₋₇CH₂CH₂O]ₓP(O)(ONH₄)_{y} where x=1 or 2; y=2 or 1 and x+y=3 in 69.2% by weight solution of isopropanol in water, from DuPont;
AN12 ZONYL® UR: [F(CF₂CF₂)₁₋₇CH₂CH₂O]ₓP(O)(OH)_{y} where x=1 or 2; y=2 or 1 and x+y=3, from DuPont;
AN13 ZONYL® TBS: 33% by weight solution of F(CF₂CF₂)₃₋₈CH₂CH₂SO₃H in a 4.5% by weight solution of acetic acid in water, from DuPont;
AN14 ammonium salt of perfluoro-octanoic acid.

According to a forty-third embodiment of the process, according to the present invention, the hydrophilic phase further contains at least one amphoteric surfactant. Suitable amphoteric surfactants include:
AMP01 AMBITERIC® H a 20% by weight solution of hexadecyldimethyl-ammonium acetic acid in ethanol

### Receiving Medium

According to a forty-fourth embodiment of the process, according to the present invention, the receiving medium is any receiving medium suitable for offset printing.

According to a forty-fifth embodiment of the process, according to the present invention, the receiving medium is paper, coated paper, a metallic foil or a plastic sheet.

According to a forty-sixth embodiment of the process, according to the present invention, the receiving medium is provided with an absorbing adhesion layer, with a gelatin layer being preferred. The adhesive layer improves the adhesion of the catalytic species to the receiving medium, particularly in the absence of a binder in the hydrophilic phase.

The receiving medium may be translucent, transparent or opaque. Suitable plastic sheets include a polymer laminate, a thermoplastic polymer foil or a duroplastic polymer foil e.g. made of a cellulose ester, cellulose triacetate, polyethylene, polypropylene, polycarbonate or polyester, with poly(ethylene terephthalate) or poly(ethylene naphthalene-1,4-dicarboxylate) being particularly preferred.

### INDUSTRIAL APPLICATION

The process according to the present invention can be used for preparing patterns of catalytic species. Electroless deposition catalyst patterns species catalyse the electroless deposition of metals, which can be used in a multiplicity of applications including electroplating with metallic layers, sensors, the production of electrical circuitry, in antennae as part of radiofrequency tags, in electroluminescent devices which can be used in lamps, displays and back-lights. The industrial application of other catalytic species can, after appropriate activation if necessary, depending upon the specific species in question, be used in abzyme catalyzed processes, to catalyse biological processes, polymerization reactions, carbon nanotubes production, processes in polymer type fuel cells and processes in membrane/electrode assemblies.

The invention is illustrated hereinafter by way of COMPARATIVE EXAMPLES and INVENTION EXAMPLES. The percentages and ratios given in these examples are by weight unless otherwise indicated.

Receiving Media:

| Receiving | |
|---|---|
| medium nr | |
| 1 | 125 μm PET with an adhesion promoting layer No. 01 |
| 2 | 125 μm PET with an adhesion promoting layer No. 01, |
| | subbing layer No. 02 and 15 m²/l gelatin layer No. 03 |
| 3 | 125 μm PET with an adhesion promoting layer No. 01, |
| | subbing layer No. 02 and 25 m²/l gelatin layer No. 03 |
| 4 | 125 μm PET with an adhesion promoting layer No. 01, |
| | subbing layer No. 02 and 50 m²/l gelatin layer No. 03 |
| 5 | PE-coated paper No. 04 with 25 m²/l gelatin layer No. 03 |

The coating solution for the adhesion promoting layer No. 01 has the following composition and was coated at 130 m²/l:

| | | |
|---|---|---|
| Copolymer of 88% vinylidene chloride, 10% methyl acrylate | 68.8 | g |
| and 2% itaconic acid | | |
| Kieselsol ™ 100F, a colloidal silica from BAYER | 16.7 | g |
| Mersolat ™ H, a surfactant from BAYER | 0.36 | g |
| Ultravon ™ W, a surfactant from CIBA-GEIGY | 1.68 | g |
| Water to make | 1000 | g |

The coating solution for the subbing layer No. 02 has the following composition and was coated at 30 m²/l:

| | | |
|---|---|---|
| Gelatin | 11.4 | g |
| Kieselsol ™ 100F-30, a colloidal silica from BAYER | 10.08 | g |
| Ultravon ™ W, a surfactant from CIBA-GEIGY | 0.4 | g |
| Arkopal | 0.2 | g |
| Hexylene glycol | 0.67 | g |
| Trimethylolpropane | 0.33 | g |
| Copolymer of 74% maleic acid, 25% styrene and 1% | 0.03 | g |
| methylmethacrylate | | |
| Water to make | 1000 | g |

The coating solution for the gelatin layer No. 03 has the following composition:

| | | |
|---|---|---|
| Gelatin | 40 | g |
| Hostapon ™ T, a surfactant from CLARIANT | 1 | g |
| Formaldehyde (4%) | 40 | g |
| Water to make | 1000 | g |

PE-coated paper No. 04 is a photographic paper from F. Schoeller, consisting of paper (166 g/m²) with a TiO₂-containing PE layer (28 g/m²), overcoated with a gelatin layer (0.25 g/m²). The backside is a layer of 47% LDPE and 53% HDPE (24 g/m²).

### EXAMPLE 1

### Offset Printing of Development Nuclei via the Fountain as Hydrophilic Phase

The preparation of palladium sulphide physical development nuclei is described in the example of EP-A 0 769 723, herein incorporated by reference. From this example, solutions A1, B1 and C1 were used to prepare a nuclei dispersion with a concentration of 0.0038 mol/l. 10 grams of isopropanol was added to 90 grams of this dispersion. This was “fountain medium A”.

10 grams of isopropanol was added to 90 grams of a dispersion of silver physical development nuclei with a concentration of 0.027 mol/l Ag and an average particle size of 5-6 nm. This was “fountain medium B”.

Printing experiments were carried out with a 360 offset printer from A.B. Dick with MT253 Yellow, a yellow offset ink from Sun Chemical, using a Thermostar™ P970/15 printing plate, receiving media 1 to 3 as described above and “fountain medium A” and fountain medium B”. With both fountain media 150 prints were made without deterioration of the print quality, the non-printed areas containing the fountain dispersion were colourless.

The preparation of the silver chlorobromide emulsion and the preparation of the transfer emulsion layer were as disclosed in EP-A 769 723 except that the coverage of silver halide applied was equivalent to 2.35 g/m² of AgNO₃ instead of 2 g/m² thereof. The transfer emulsion layer was processed in contact with the receiving media listed above at 25° C. for 1 minute with an AGFA-GEVAERT™ CP297 developer solution and subsequently dried at room temperature.

After carrying out this diffusion transfer reversal (DTR) process, a silver grey pattern was observed in the non-inked areas for both “fountain medium A” and “fountain medium B” with both receiving medium 2 and receiving medium 3, showing that development nuclei had been transferred to the receiving media during printing. No coloration was observed in the case of receiving medium 1 after carrying out this diffusion transfer reversal (DTR) process.

The silver areas on receiving medium 2 with “fountain medium A” showed a resistance of 1500 Ω/square. The silver areas on the other samples showed no conductivity. During separation of the transfer emulsion layer and the (hydrophilic) receiving media 2 and 3, the (hydrophobic) yellow ink was transferred to the transfer emulsion layer, while the yellow ink remained on receiving medium 1 after separation.

An additional copper layer was grown on top of the silver pattern by immersing it for 4 minutes in a reducer bath (Reducer Neoganth 406 from Atotech), followed by electroless plating in a copper bath (Printoganth PV from Atotech) for 30 minutes. Copper was only deposited on the silver pattern, resulting in a change from a grey to a copper-coloured pattern.

### EXAMPLE 2

### Increasing Conductivity via a Diffusion Transfer Reversal Process

Development nuclei were printed via “fountain medium A” on receiving medium 2 and then developed via the diffusion transfer reversal process described in example 1. The resistance was 1500 Ω/square. The receiving medium was then developed for a second time via the diffusion transfer reversal process, using the same conditions as described before, resulting in a resistance of 100 Ω/square. Since the transfer emulsion layer did not have to be photoexposed, problems of misalignment of the transfer emulsion layer to the already patterned receiving medium did not occur.

A single DTR process step in which the contact time was increased from 1 to 3 minutes, did not give a reduction in surface resistance compared with the two subsequent DTR processes.

### EXAMPLE 3

### Increasing Conductivity via the Fountain as Hydrophilic Phase

Solutions A1, B1 and C1 were prepared as given below:

| | (NH₄)₂PdCl₄ | Na₂S | 1% solution of polyvinyl alcohol | deionized |
|---|---|---|---|---|
| | [g] | [g] | in deionized water [ml] | water [ml] |
| A1 | 2.17 | | 25 | 475 |
| B1 | | 2 | 25 | 475 |
| C1 | | 3.2 | 40 | 760 |

The physical development nuclei were prepared, as described in the EXAMPLE in EP-A 0 769 723, by a double jet precipitation in which solution A1 of (NH₄)₂PdCl₄ and solution B1 of sodium sulphide were added at a constant rate during 4 minutes to solution C1 containing sodium sulphide while stirring at 400 rpm. Subsequent to precipitation, the precipitated nuclei obtained were dialysed to a conductivity of 0.5 mS. A 250 g sample of this dispersion was concentrated by evaporation to 50 g and 5 g isopropanol was added. This was “fountain medium C”.

Printing was performed as described in Example 1 on receiving medium 5, with both “fountain medium A” and “fountain medium C”.

After DTR development was performed as described in Example 1, a silver grey pattern was formed in the non-inked areas with receiving medium 5 printed with both “fountain medium A” and “fountain medium C”. With “fountain medium A”, the silver areas showed no conductivity, whereas the surface resistance realized with “fountain medium C” was 170 1Ω/square. Hence an increase in the development nuclei concentration in the fountain medium improved the amount of deposited silver and thus the conductivity. The conductivity could be increased even further by a second DTR process, resulting in a resistance of 30 Ω/square.

### EXAMPLE 4

### Increasing Conductivity via Additional Coating Step

Development nuclei were printed via the “fountain medium A” on receiving media 1, 2, 4 and 5 as described in Example 1. The prints were then overcoated with “fountain medium A” with a nominal wet coating thickness of 10 μm. The fountain medium dewetted the yellow inked hydrophobic areas and preferentially covered the ‘fountain areas’. After drying at room temperature, the prints were developed via DTR and dried, resulting in conductive patterns with the resistances shown in the table below.

When DTR development was performed on thereby printed receiving media 2 to 5, which all had a gelatin outermost layer, silver layers with surface resistances of 5 to 20 Ω/square were obtained, whereas in absence of a gelatin outermost layer, as in receiving medium 1, no silver was deposited on the nuclei pattern.

| Receiving | | Gelatin layer | Resistance |
|---|---|---|---|
| medium nr. | Support | thickness | (Ω/square) |
| 1 | PET + adhesion layer | — | >30 × 10⁶ |
| 2 | PET + adhesion layer + | 1.2 | 20 |
| | gelatine layer (15 m²/L) | | |
| 4 | PET + adhesion layer + | 4.2 | 5 |
| | gelatine layer (50 m²/L) | | |
| 5 | PE-coated paper + | 2.1 | 6 |
| | gelatine layer (25 m²/L) | | |

It was further found that the surface resistance of the layer obtained by DTR-processing of the development nuclei on receiving medium 2 could be reduced by a factor of 7.6 upon sintering together the silver particles formed in the DTR process by heating with an energy of 1250 mJ/cm² using a IR diode laser (wavelength 830 nm) beam.

The present invention may include any feature or combination of features disclosed herein either implicitly or explicitly or any generalisation thereof irrespective of whether it relates to the presently claimed invention. In view of the foregoing description it will be evident to a person skilled in the art that various modifications may be made within the scope of the invention.

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An offset printing process comprising the steps of: applying a hydrophilic phase to a printing plate with or without an oleophilic phase, the hydrophilic phase comprising at least one catalytic species, and applying said hydrophilic phase applied to said printing plate to a receiving medium thereby realizing in a single step a functional pattern of said at least one catalytic species on said receiving medium, wherein, if said hydrophilic phase is applied with said oleophilic phase, said oleophilic and hydrophilic phases are either applied separately from an ink and a fountain medium or are applied together in the form of a single fluid ink, wherein said single fluid ink of comprising a dispersing phase and a dispersed phase, and wherein said hydrophilic phase is exclusive of an ionomer.

2. An offset printing process according to claim 1, wherein said at least one catalytic species requires no activation prior to said at least one catalytic species exhibiting catalytic activity.

3. An offset printing process according to claim 1, wherein said dispersing phase in said single phase ink is said hydrophilic phase.

4. An offset printing process according to claim 1, wherein said catalytic species is present in said hydrophilic phase as a solution.

5. An offset printing process according to claim 1, wherein said catalytic species is present in said hydrophilic phase as a dispersion.

6. An offset printing process according to claim 1, wherein said hydrophilic phase applied without an oleophilic phase is a water-based driographic ink.

7. An offset printing process according to claim 1, wherein said catalytic species is selected from the group consisting of metallic particles, organic compounds, inorganic compounds, organometallic compounds, polymers, microporous species, microorganisms, antibodies, and enzymes exclusive of water-soluble hydrolase enzymes.

8. An offset printing process according to claim 1, wherein said catalytic species is selected from the group consisting of electroless deposition catalysts, electrocatalysts, development nuclei, polymerization catalysts, structure specific catalysts, biological process catalysts, biochemical process catalysts, fuel cell catalysts, diffusion catalysts and gas-phase reaction catalysts.

9. An offset printing process according to claim 1, wherein said hydrophilic phase further contains at least one non-ionic or anionic surfactant.

10. An offset printing process according to claim 1, wherein said fountain medium is said hydrophilic phase.

11. An offset printing process according to claim 1, wherein said ink is said hydrophilic phase.

12. An offset printing process according to claim 1, wherein said fountain medium has a viscosity at 25° C. after stirring to constant viscosity of at least 0.75 mPa.s as measured according to DIN 53211.

13. An offset printing process according to claim 1, wherein said fountain medium has a viscosity at 25° C. after stirring to constant viscosity of at least 30 mPa.s as measured according to DIN 53211.

14. An offset printing process according to any of the preceding claims, wherein, if said oleophilic phase is colored, said fountain medium contains a dye and/or a pigment such that the color tone of the ink and the background cannot be distinguished by the human eye.

15. An offset printing process according to claim 1, wherein, if said hydrophilic phase is colored, said oleophilic phase contains a dye and/or a pigment such that the color tone of the ink and the background cannot be distinguished by the human eye.
